(19) United States
(12) Patent Application Publication
(10) Pub. No.: US 2006/0227686 A1
(43) Pub. Date: Oct. 12, 2006

(54) Recording information management apparatus and recording information management method

(75) Inventor: Tomoaki Nakade, Osato-gun (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/398,699

(22) Filed: Apr. 6, 2006

(30) Foreign Application Priority Data
Apr. 7, 2005 (JP) 2005-111139

(51) Int. Cl. G11B 7/00

(52) U.S. Cl. 369/53.2

(57) ABSTRACT

According to one embodiment, in a recording information management method, an erase condition set for each recording mode is managed, recording of predetermined recording target information in a designated predetermined recording mode is controlled, and the predetermined recording target information recorded in the predetermined recording mode is managed based on a predetermined erase condition set for a predetermined recording mode.

### CROSS-REFERENCE TO RELATED APPLICATIONS

This application is based upon and claims the benefit of priority from prior Japanese Patent Application No. 2005-111139, filed Apr. 7, 2005, the entire contents of which are incorporated herein by reference.

### BACKGROUND

1. Field

One embodiment of the invention relates to a recording information management apparatus and recording information management method, which can be applied to a recording apparatus for recording information such as a received program.

2. Description of the Related Art

In recent years, a video recording apparatus which records video data in an HDD (Hard Disk Drive) has greatly prevailed. The HDD preferably has a large capacity, but the storage capacity is finite. That is, when a program is to be continuously recorded in an HDD, the capacity of the HDD becomes short. In such a case, in order to further record the program, one or more programs recorded in the HDD must be erased to ensure the free space of the HDD.

For example, Jpn. Pat. Appln. KOKAI Publication No. 2004-328591 and PCT(WO) 2004-531120 disclose a technique of deleting predetermined data of a low priority when a capacity becomes short, thereby eliminating the shortage of the capacity.

Also, Jpn. Pat. Appln. KOKAI Publication No. 2004-7155 discloses a technique capable of controlling partial erase/non-erase of a program to ensure the free space of a recording medium.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing an outer appearance of a digital television broadcast receiving apparatus (recording information management apparatus) according to an embodiment of the invention;

FIG. 2 is a block diagram showing the schematic arrangement of the digital television broadcast receiving apparatus (recording information management apparatus) according to the embodiment;

FIG. 3 is a view showing an example of an erase condition setting menu according to the embodiment; and

FIG. 4 is a view showing a state wherein information indicating “unlocked” for permitting erase, and “locked” for inhibiting erase is supplied to a recorded program according to the embodiment.

### DETAILED DESCRIPTION

Various embodiments according to the invention will be described hereinafter with reference to the accompanying drawings. In general, according to one embodiment of the invention, a recording information management method comprises managing an erase condition set for each recording mode, controlling recording of predetermined recording target information in a designated predetermined recording mode, and managing, based on a predetermined erase condition set for a predetermined recording mode, the predetermined recording target information recorded in the predetermined recording mode.

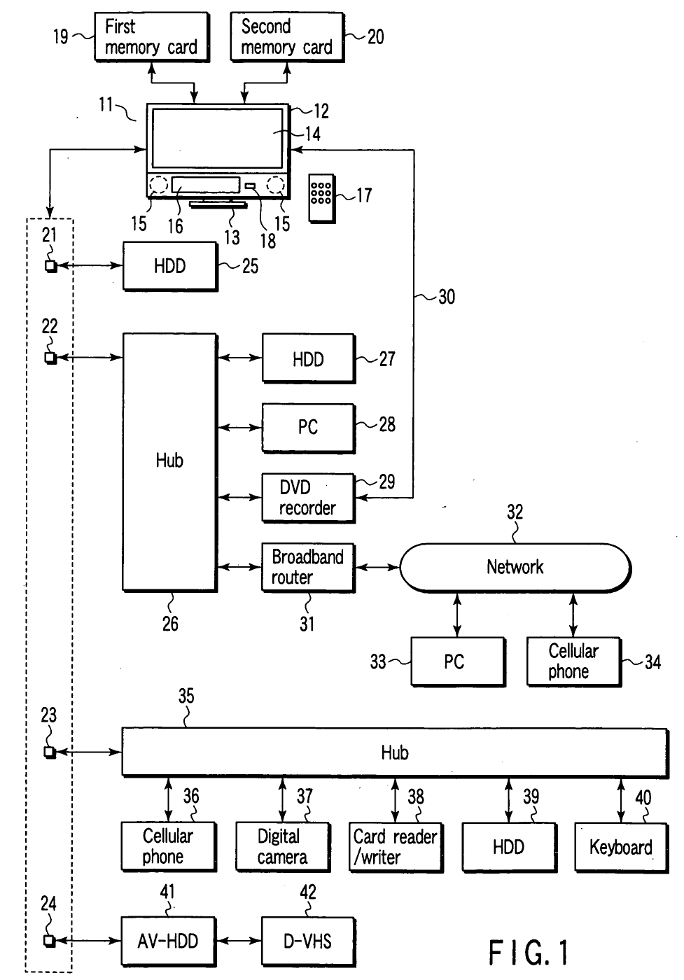

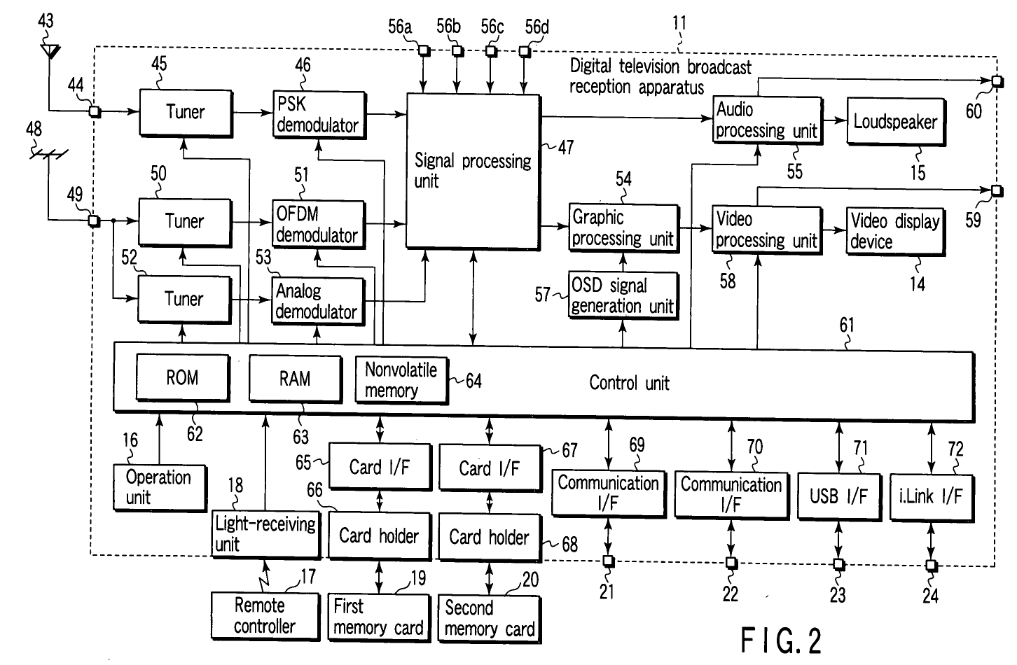

Referring to FIGS. 1 and 2, a digital television broadcast receiving apparatus (recording information management apparatus) will be described according to an embodiment. FIG. 1 is a block diagram showing an outer appearance of the digital television broadcast receiving apparatus (recording information management apparatus) according to this embodiment. FIG. 2 is a block diagram showing the schematic arrangement of the digital television broadcast receiving apparatus (recording information management apparatus).

A digital television broadcast receiving apparatus 11 mainly includes a flat cabinet 12 and a support base 13 which vertically supports the cabinet 12. The cabinet 12 includes a video display device 14 which comprises a liquid crystal display panel or the like, a loudspeaker 15, an operation unit 16, and a light-receiving unit 18 which receives operation information transmitted from a remote controller 17.

A first memory card 19 such as an SD (Secure Digital) memory card, MMC (Multimedia Card), or memory stick is detachable from the digital television broadcast receiving apparatus 11 to execute recording and playback of information such as a program and photograph using the first memory card 19.

A second memory card (IC card) 20 which records contract information and the like is also detachable from the digital television broadcast receiving apparatus 11 to execute recording and playback of information using the second memory card 20.

The digital television broadcast receiving apparatus 11 also has a first LAN (Local Area Network) terminal 21, second LAN terminal 22, USB (Universal Serial Bus) terminal 23, and i. Link terminal 24.

Of these terminals, the first LAN terminal 21 serves as a LAN-compatible HDD dedicated port, and is used to execute recording and playback of information by the Ethernet® using a LAN-compatible HDD 25 serving as a connected NAS (Network Attached Storage).

Since the first LAN terminal 21 serves as the LAN-compatible HDD dedicated port, program information can be stably recorded in the HDD 25 with high-resolution image quality without being influenced by another network environment, a network usage condition, or the like.

The second LAN terminal 22 serves as a general LAN-compatible port using the Ethernet®. For example, the second LAN terminal 22 is connected to a LAN-compatible HDD 27, PC (Personal Computer) 28, HDD built-in type DVD (Digital Versatile Disk) recorder 29, and the like via a hub 26, and is used to transmit information to these devices.

Note that digital information communicated via the second LAN terminal 22 is only control system information for the DVD recorder 29. Hence, a dedicated analog transmission channel 30 must be arranged in order to transmit analog video and audio information between the DVD recorder 29 and the digital television broadcast receiving apparatus 11.

The second LAN terminal 22 is also connected to a network 32 such as the Internet via a broadband router 31 connected to the hub 26, and used to transmit information to a PC 33, cellular phone 34, and the like via the network 32.

The USB terminal 23 serves as a general USB-compatible port. For example, the USB terminal 23 is connected to USB devices such as a cellular phone 36, a digital camera 37, a card reader/writer 38 for a memory card, an HDD 39, and a keyboard 40 via a hub 35, and is used to transmit information to these USB devices.

The i. Link terminal 24 is serially connected to, e.g., an AV-HDD 41 and D (Digital)-VHS (Video Home System) 42, and is used to transmit information to these devices.

FIG. 2 shows the main signal processing system of the above-described digital television broadcast receiving apparatus 11. That is, a satellite digital television broadcast signal received by a BS/CS digital broadcast receiving antenna 43 is supplied to a satellite digital broadcast tuner 45 via an input terminal 44 to tune the tuner to the broadcast signal of a desired channel.

The broadcast signal to which the tuner 45 is tuned is supplied to a PSK (Phase Shift Keying) demodulator 46, and demodulated into digital video and audio signals. After that, the demodulated signals are output to a signal processing unit 47.

A terrestrial digital television broadcast signal received by a terrestrial broadcast receiving antenna 48 is supplied to a terrestrial digital broadcast tuner 50 via an input terminal 49 to tune the tuner to the broadcast signal of a desired channel.

The broadcast signal to which the tuner 50 is tuned is supplied to an OFDM (Orthogonal Frequency Division Multiplexing) demodulator 51, and demodulated into digital video and audio signals. After that, the demodulated signals are output to the signal processing unit 47.

The terrestrial analog television broadcast signal received by the terrestrial broadcast receiving antenna 48 is supplied to a terrestrial analog broadcast tuner 52 via the input terminal 49 to tune the tuner to the broadcast signal of a desired channel. The broadcast signal to which the tuner 52 is tuned is then supplied to an analog demodulator 53, and demodulated into analog video and audio signals. After that, the demodulated signals are output to the signal processing unit 47.

Note that, the signal processing unit 47 selectively performs a predetermined digital signal process for the digital video and audio signals respectively supplied from the PSK demodulator 46 and the OFDM demodulator 51. The video and audio signals are output to a graphic processing unit 54 and an audio processing unit 55.

A plurality of (four in FIG. 2) input terminals 56a, 56b, 56c, and 56d are connected to the signal processing unit 47. Each of the input terminals 56a to 56d can receive analog video and audio signals from an external device of the digital television broadcast receiving apparatus 11.

The signal processing unit 47 selectively converts the analog video and audio signals supplied from each of the analog demodulator 53 and the input terminals 56a to 56d into the digital signals. The predetermined digital signal process is performed for the digital video and audio signals. After that, the digital video and audio signals are output to the graphic processing unit 54 and the audio processing unit 55.

Of these processing units, the graphic processing unit 54 has a function of superposing an OSD (On Screen Display) signal generated by an OSD signal generation unit 57 on the digital video signal supplied from the signal processing unit 47, and outputting the resultant signal. The graphic processing unit 54 can selectively output the output video signal from the signal processing unit 47 or the output OSD signal from the OSD signal generation unit 57, or output both the output signals, respectively, on the halves of the window in combination.

The digital video signal output from the graphic processing unit 54 is supplied to a video processing unit 58. The video processing unit 58 converts the input digital video signal into an analog video signal in a format which can be displayed by the video display device 14. After that, the converted analog video signal is output to the video display device 14 for displaying the video signal. The video signal is also output to the external device via an output terminal 59.

The audio processing unit 55 converts the input digital audio signal into the analog audio signal in a format which can be played back by the loudspeaker 15. After that, the converted audio signal is output to the loudspeaker 15 to play back the audio signal. The audio signal is also output to the external device via an output terminal 60.

Note that the control unit 61 systematically controls the operations including the above-described various reception operations of the overall digital television broadcast receiving apparatus 11. The control unit 61 incorporates a CPU (Central Processing Unit) to receive operation information from the operation unit 16. The control unit 61 also receives operation information from the remote controller 17 via the light-receiving unit 18, and controls each device to reflect these operation contents.

In this case, the control unit 61 mainly uses a ROM (Read Only Memory) 62 storing a control program executed by this CPU, a RAM (Random Access Memory) 63 for providing a work area to this CPU, and a nonvolatile memory 64 for storing various setting information and control information.

The control unit 61 is connected, via a card I/F (Interface) 65, to a card holder 66 to which the first memory card 19 can be inserted. In this arrangement, the control unit 61 can transmit, via the card I/F 65, information to the first memory card 19 inserted to the card holder 66.

The control unit 61 is also connected, via a card I/F 67, to a card holder 68 to which the second memory card 20 can be inserted. In this arrangement, the control unit 61 can transmit, via the card I/F 67, information to the second memory card 20 inserted to the card holder 68.

The control unit 61 is also connected to the first LAN terminal 21 via a communication I/F 69. In this arrangement, the control unit 61 can transmit, via the communication I/F 69, information to the LAN-compatible HDD 25 connected to the first LAN terminal 21. In this case, the control unit 61 has a DHCP (Dynamic Host Configuration Protocol) server function to control to allocate an IP (Internet Protocol) address to the LAN-compatible HDD 25 connected to the first LAN terminal 21.

The control unit 61 is also connected to the second LAN terminal 22 via a communication I/F 70. In this arrangement, the control unit 61 can transmit, via the communication I/F 70, information to the devices (see FIG. 1) connected to the second LAN terminal 22.

The control unit 61 is also connected to the USB terminal 23 via a USB I/F 71. In this arrangement, the control unit 61 can transmit, via the USB I/F 71, information to the devices (see FIG. 1) connected to the USB terminal 23.

The control unit 61 is also connected to the i. Link terminal 24 via an i. Link I/F 72. In this arrangement, the control unit 61 can transmit, via the i. Link I/F 72, information to the devices (see FIG. 1) connected to the i. Link terminal 24.

A recording mode of the above-described digital television broadcast reception apparatus 11 will be described next. For example, the digital television broadcast reception apparatus 11 has the first, second, and third recording modes. Based on these recording modes, predetermined programs (recording target information) are recorded on, e.g., the HDD 25.

The first recording mode is a mode of recording a program based on reservation information, and is called “reservation recording”. The reservation information is generated in accordance with information such as date and time, channel, and recording designation (e.g., HDD 25) designated by the operation unit 16 or remote controller 17, and is stored in the nonvolatile memory 64. Based on the reservation information stored in the nonvolatile memory 64, the control unit 61 controls operation to record the program of the designated channel in the designated recording destination at the designated date and time.

The second recording mode is a mode of recording a selected (currently viewed) program, and is called “currently-viewed program recording”. When “currently-viewed program recording” is designated by the operation unit 16 or remote controller 17 during viewing a program, the currently viewed program is recorded in a predetermined recording destination (e.g., HDD 25) upon recording control by the control unit 61. Note that the end time of the currently viewed program is detected based on, e.g., an EPG (Electric Program Guide). With this operation, the currently viewed program can be recorded till the end time. The EPG is included in a broadcast signal supplied via the input terminal 49. The EPG may be obtained via the second LAN terminal 22.

The third recording mode is a mode of recording a program based on designation of recording start timing and recording end timing, and is called “manual partial recording”. When a recording start instruction is issued by the operation unit 16 or remote controller 17 during viewing a program, the currently viewed program starts being recorded upon recording control by the control unit 61. When a recording end instruction is issued by the operation unit 16 or remote controller 17, the currently viewed program stops being recorded upon recording control by the control unit 61. Note that a recording destination (e.g., HDD 25) is designated in advance.

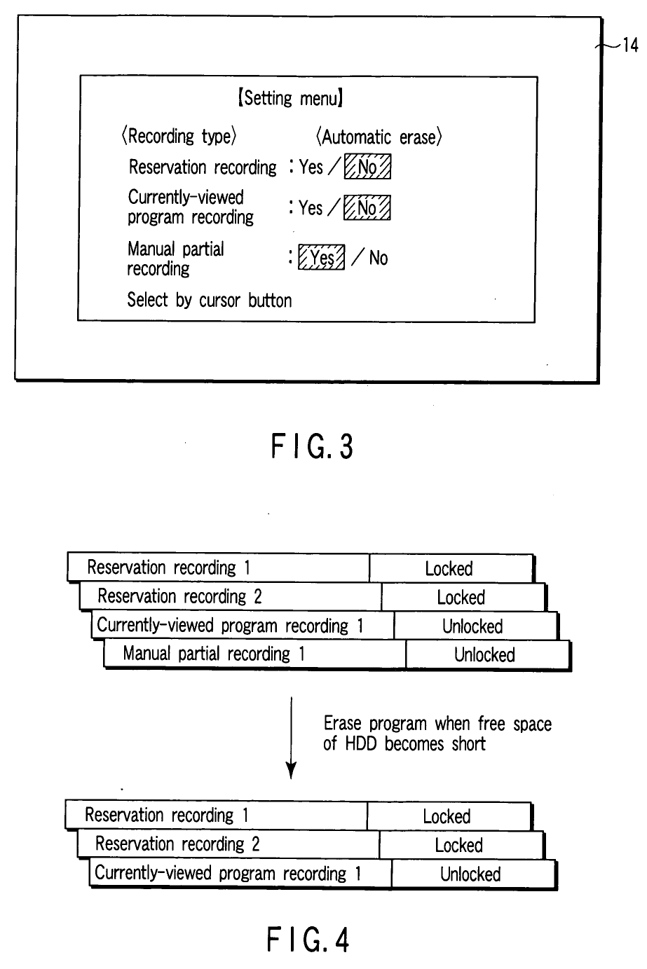

Erase condition setting for each recording mode will be described next. When an erase condition setting instruction is issued by the operation unit 16 or remote controller 17, the control unit 61 serving as a management unit for managing an erase condition controls to display a default erase condition setting menu stored in the nonvolatile memory 64. With this operation, the erase condition setting menu is displayed on the video display device 14 as shown in FIG. 3. In accordance with the instruction from the operation unit 16 or remote controller 17, automatic erase setting for each recording mode can be implemented in this erase condition setting menu. That is, a user can set whether a program recorded in the first recording mode (reservation recording) can be automatically erased. The user can also set whether a program recorded in the second recording mode (currently-viewed program recording) can be automatically erased. The user can also set whether a program recorded in the third recording mode (manual partial recording) can be automatically erased.

In FIG. 3, an erase condition for inhibiting automatic erase is set for a program recorded in the first recording mode. The erase condition for inhibiting automatic erase is also set for a program recorded in the second recording mode. An erase condition for permitting automatic erase is set for a program recorded in the third recording mode. The erase condition set in the erase condition setting menu is stored in, e.g., the nonvolatile memory 64.

The control unit 61 serving as a recording control unit controls recording of a program in a recording mode designated by the operation unit 16 or remote controller 17. At this time, the control unit 61 supplies lock information under the set erase condition to the recorded program to manage the recorded program. For example, in FIG. 4, when the erase condition for inhibiting automatic erase is set for a program recorded in the first recording mode (reservation recording), the control unit 61 supplies lock information indicating “locked” to a program (reservation recording 1) recorded in the first recording mode. Similarly, the control unit 61 supplies the lock information indicating “locked” to a program (reservation recording 2) recorded in the first recording mode. When the erase condition for permitting automatic erase is set for a program recorded in the second recording mode (currently-viewed program recording), the control unit 61 supplies lock information indicating “unlocked” to a program (currently-viewed program recording 1) recorded in the second recording mode. When the erase condition for permitting automatic erase is set for a program recorded in the third recording mode (manual partial recording), the control unit 61 supplies the lock information indicating “unlocked” to a program (manual partial recording 1) recorded in the third recording mode.

The control unit 61 serving as a management unit for managing a recorded program based on an erase condition detects the shortage of the free area of the HDD 25 (detects a state change), and controls to erase the program in the HDD 25 under the set erase condition. That is, as described above, the recorded program with the lock information indicating “unlocked” is erased. Note that when the percentage of the free space with respect to the total capacity of the HDD 25 becomes lower than a predetermined value, the control unit 61 detects the shortage of the free space. When the free space of the HDD 25 becomes smaller than a predetermined capacity, the control unit 61 also detects the shortage of the free space. When the control unit 61 predicts that the percentage of the free space with respect to the total capacity of the HDD 25 becomes lower than a predetermined value upon recording reservation or the like, the control unit 61 also detects the shortage of the free space. Similarly, when the control unit 61 predicts that the free space of the HDD 25 becomes smaller than the predetermined capacity upon recording reservation or the like, the control unit 61 also detects the shortage of the free space.

In addition to the above-described erase conditions, automatic erase of a recorded program may be managed based on the attribute information of the recorded program. The attribute information includes information such as the recording date and time, genre, and size of the recorded program. (Assume that the control unit 61 detects the shortage of the free space of the HDD 25, and detects a plurality of recorded programs each having the lock information indicating “unlocked”. That is, when a plurality of recorded programs can be erased, the control unit 61 decides, based on the attribute information supplied to each recorded program, a recorded program to be erased. With this operation, for example, an older recorded program can be preferentially erased. Program information which does not correspond to a genre registered as a favorite of a user can also be preferentially erased. A large-size (or small-size) recorded program can also be preferentially erased. For example, when a program having a large capacity is reserved for recording, and the shortage of the free space is detected based on this reservation, a large-size recorded program is preferably erased, effectively.

As described above, a recorded program can be automatically deleted according to user's intention, and the free space of the recording destination of a recorded program can easily be ensured. Hence, the storage capacity can effectively be used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording information management apparatus comprising:
a first management unit configured to manage an erase condition set for each recording mode;
a recording control unit configured to control recording of predetermined recording target information in a designated predetermined recording mode; and
a second management unit configured to manage, based on a predetermined erase condition set for the predetermined recording mode, the predetermined recording target information recorded in the predetermined recording mode.

2. An apparatus according to claim 1, wherein the second management unit controls erase of the predetermined recording target information based on the predetermined erase condition.

3. An apparatus according to claim 1, wherein the recording control unit manages an erase condition set for a first recording mode for recording recording target information based on reservation information, a second recording mode for recording selected recording target information, and a third recording mode for recording recording target information based on designation of recording start timing and recording end timing.

4. An apparatus according to claim 1, wherein the first management unit manages a first erase condition for permitting erase of recording target information based on a state change, and a second erase condition for inhibiting erase of recording target information based on the state change.

5. An apparatus according to claim 1, wherein the first management unit manages a first erase condition for permitting erase of recording target information based on a shortage of a capacity of a recording destination, and a second erase condition for inhibiting erase of recording target information based on the shortage of the capacity of the recording destination.

6. An apparatus according to claim 1, wherein the second management unit manages predetermined recording target information based on the predetermined erase condition set for the predetermined recording target information, and an attribute of the predetermined recording target information.

7. An apparatus according to claim 1, wherein the second management unit controls erase of the predetermined recording target information based on the predetermined erase condition set for the predetermined recording target information, and an attribute of the predetermined recording target information.

8. An apparatus according to claim 1, wherein the attribute includes at least one of recording date and time of the predetermined recording target information, a genre of the predetermined recording target information, and a size of the predetermined recording target information.

9. A recording information management method comprising:
managing an erase condition set for each recording mode;
controlling recording of predetermined recording target information in a designated predetermined recording mode; and
managing, based on a predetermined erase condition set for the predetermined recording mode, the predetermined recording target information recorded in the predetermined recording mode.

10. A method according to claim 9, further comprising:
controlling erase of the predetermined recording target information based on the predetermined erase condition.

11. A method according to claim 9, further comprising:
managing an erase condition set for a first recording mode for recording recording target information based on reservation information, a second recording mode for recording selected recording target information, and a third recording mode for recording recording target information based on designation of recording start timing and recording end timing.

12. A method according to claim 9, further comprising:
managing a first erase condition for permitting erase of recording target information based on a state change, and a second erase condition for inhibiting erase of recording target information based on the state change.

13. A method according to claim 9, further comprising:
managing a first erase condition for permitting erase of recording target information based on a shortage of a capacity of a recording destination, and a second erase condition for inhibiting erase of recording target information based on the shortage of the capacity of the recording destination.

14. A method according to claim 9, further comprising:
managing predetermined recording target information based on the predetermined erase condition set for the predetermined recording target information, and an attribute of the predetermined recording target information.

15. A method according to claim 9, further comprising:
controlling erase of the predetermined recording target information based on the predetermined erase condition set for the predetermined recording target information, and an attribute of the predetermined recording target information.

16. A method according to claim 9, further comprising:
the attribute includes at least one of recording date and time of the predetermined recording target information, a genre of the predetermined recording target information, and a size of the predetermined recording target information.
